(19) United States
(12) Patent Application Publication
(10) Pub. No.: US 2008/0169194 A1
(43) Pub. Date: Jul. 17, 2008

(54) Polypeptide Marker for the Diagnosis of Ateriosclerosis

(76) Inventor: Harald Mischak, Sehnde (DE)

Correspondence Address: JACOBSON HOLMAN PLLC, 400 SEVENTH STREET N.W., SUITE 600, WASHINGTON, DC, 20004, US

(21) Appl. No.: 11/661,694

(22) PCT Filed: Sep. 1, 2005
(86) PCT No.: PCT/EP05/54314

§ 371 Date: Sep. 10, 2007

(30) Foreign Application Priority Data
Sep. 2, 2004 (DE) 102004042530.2

(51) Int. Cl. B01D 57/02; B01D 59/44

(52) U.S. Cl. 204/451; 250/282

(57) ABSTRACT

The present invention relates to the use of the presence or absence of one or more peptide markers in a sample from a subject for the diagnosis of arteriosclerosis and to a method for the diagnosis of arteriosclerosis, wherein the presence or absence of the peptide marker or markers is indicative of the existence of arteriosclerosis.

The present invention relates to the use of the presence or absence of one or more peptide markers in a sample from a subject for the diagnosis of arteriosclerosis and to a method for the diagnosis of arteriosclerosis, wherein the presence or absence of the peptide marker or markers is indicative of the existence of arteriosclerosis.

Arteriosclerosis or atherosclerosis, vascular or arterial calcification is the most abundant pathologic vascular alteration. Arteriosclerosis is an alteration of the blood vessels which forms over many years and remains unrecognized at first. Blood lipids and white blood cells become enriched at the vascular walls (plaque formation), the vessels become calcified, lose their elasticity, and the vascular diameter becomes increasingly narrowed. Risk factors for the formation of arteriosclerosis are believed to include hypercholesterolemia, hypertension, smoking, diabetes mellitus, adiposity, physical inactivity and a low social state, which is closely related to other factors however. Further risk factors, such as hypertriglyceridemia, increased blood levels of lipoprotein(a), homocysteine and particular inflammation parameters, such as c-reactive protein (CRP) or fibrinogen, as well as chronic Chlamydia or Helicobacter pylori infections are being discussed.

Arteriosclerosis does not cause any symptoms for a long time. Only when the vascular diameter has become clearly reduced by the plaques or a blood clot (thrombus) forms in the region of the plaques, symptoms occur. The most abundant arteriosclerotic cardiac and vascular diseases are coronary heart disease, cerebrovascular diseases and peripheral arterial occlusive disease; their dreaded complications, i.e., myocardial infarction, stroke or the loss of lower limbs, occur extraordinarily often in Germany as compared to less developed countries and cause extremely high costs for public health.

Arteriosclerosis-caused cardiovascular diseases are on top of the German statistics of causes of death. Thus, in 1999, cardiovascular diseases were the most frequent cause of death at 48% according to the German Statistisches Bundesamt, ischemic (coronary) heart diseases accounting for 21% and diseases of the cerebrovascular system for 10%. In comparison, the proportion of cancers with fatal consequences was 26%, and that of diseases of the respiratory and digestive tracts was 6% and 5%, respectively.

Although arteriosclerotic alterations often occur already in youth, the patients mostly develop clinical signs only from a medium and higher age.

Arteriosclerosis cannot be treated by medicaments, but can only be avoided by prophylaxis. Calcifications that have already occurred cannot be broken down, and the elasticity cannot be returned to the rigid vascular walls. However, the progression of arteriosclerosis can be clearly slowed down by influencing the risk factors by changing the way of living, such as by nicotine abstinence, or with medicaments (e.g., acetylsalicylic acid). In addition, for severe arterial calcifications, surgical methods, such as balloon angioplasty (PTA, percutaneous transluminal angioplasty), bypass surgery and the insertion of stents, are available.

Since, as explained above, arteriosclerotic alterations cannot be treated therapeutically, but can only be avoided or slowed down, early recognition of arteriosclerotic alterations is particularly important.

Under normal circumstances, only the diagnosis of a secondary disease allows the conclusion that the affected person suffers from arteriosclerosis. Presently, to this end, the constrictions of the blood vessels are detected, for example, by means of contrast agents or X-rays or ultrasound. In addition, the risk factors, such as increased cholesterol levels or a diabetes, are usually examined. However, all these methods are not sufficient for an early and reliable diagnosis of arteriosclerosis. In particular, there is a need for a quick and inexpensive early recognition of arteriosclerosis which is as little invasive as possible.

Surprisingly, it has now been found that particular peptide markers in the sample from a subject can be used for the diagnosis of arteriosclerosis.

Thus, the present invention relates to the use of the presence or absence of at least one peptide marker in a sample from a subject for the diagnosis of arteriosclerosis, wherein said polypeptide marker is selected from the polypeptide markers No. 1, No. 2, No. 3, No. 4, No. 5, No. 6, No. 7, No. 8 or No. 9, which are characterized by the values for the molecular masses as stated in Table 1:

TABLE 1
Polypeptide markers for the diagnosis of arteriosclerosis
and their molecular masses

| Polypeptide marker No. | Molecular mass [Da] |
|---|---|
| 1 | 2511.8 |
| 2 | 1864.7 |
| 3 | 2799.8 |
| 4 | 1340.6 |
| 5 | 1422.8 |
| 6 | 5882.0 |
| 7 | 1397.4 |
| 8 | 1886.6 |
| 9 | 4642.6 |

With the present invention, it is possible to diagnose arteriosclerosis at a very early stage. Thus, the disease can be treated by known therapeutic approaches at an early stage or before its manifestation, and thus its further course can be alleviated. The invention further enables an inexpensive, quick and reliable diagnosis of arteriosclerosis with in part non-invasive or minimal-invasive procedures.

In a particular embodiment of the invention, the polypeptide marker is characterized not only by its molecular weight, but also by its migration time (see Table 2):

TABLE 2
Polypeptide markers for the diagnosis of arteriosclerosis
and their molecular masses and migration times

| Polypeptide marker No. | Molecular mass [Da] | Migration time [min] |
|---|---|---|
| 1 | 2511.8 | 26.4 |
| 2 | 1864.7 | 49.2 |
| 3 | 2799.8 | 46.0 |
| 4 | 1340.6 | 66.7 |
| 5 | 1422.8 | 61.2 |
| 6 | 5882.0 | 33.3 |
| 7 | 1397.4 | 24.9 |
| 8 | 1886.6 | 44.7 |
| 9 | 4642.6 | 37.5 |

The migration time is determined by capillary electrophoresis (CE), for example, as set forth in the Example under item 2. Thus, a glass capillary of 90 cm in length and with an inner diameter (ID) of 75 μm and an outer diameter (OD) of 360 μm is operated at a voltage of 30 kV. As the solvent for the sample, 30% methanol, 0.5% formic acid in water is used.

It is known that the CE migration times may vary. Nevertheless, the order in which the polypeptide markers are eluted is typically the same for any CE system employed. In order to balance the differences in the migration time, the system may be normalized using standards for which the migration times are known. These standards may be, for example, the polypeptides stated in the Examples (see the Example, item 3, “standard for CE measurement”).

The characterization of the polypeptide markers shown in Tables 1 to 3 was determined by means of capillary electrophoresis-mass spectrometry, CE-MS), a method which has been described in detail, for example, by Neuhoff et al. (Rapid Communications in mass spectrometry, Vol. 20: 149-156, 2004). The variation of the molecular masses between individual measurements or between different mass spectrometers is relatively small, typically within a range of ±0.1%, preferably within a range of ±0.05%.

The polypeptide markers according to the invention are proteins or peptides or degradation products of proteins or peptides. They may be chemically modified, for example, by posttranslational modifications, such as glycosylation, phosphorylation, alkylation or disulfide bridges, or by other reactions, for example, within the scope of the degradation. In addition, the polypeptide markers may also be chemically altered, for example, oxidized, within the scope of the purification of the samples.

Proceeding from the parameters that determine the polypeptide markers (molecular weight and migration time), it is possible to identify the sequence of the corresponding polypeptides by methods known in the prior art.

The polypeptides according to the invention (see Table 1 or 2) are used to diagnose arteriosclerosis. “Diagnosis” means the process of knowledge gaining by assigning symptoms or phenomena to a disease or injury. In the present case, the existence of arteriosclerosis is concluded from the presence or absence of particular polypeptide markers. Thus, the polypeptide markers according to the invention are determined in a sample from a subject, wherein its presence or absence allows to conclude the existence of arteriosclerosis. The presence or absence of a polypeptide marker can be measured by any method known in the prior art. Methods which may be known are exemplified below.

A polypeptide marker is considered present if its measured value is at least as high as its threshold value. If the measured value is lower, then the polypeptide marker is considered absent. The threshold value can be determined either by the sensitivity of the measuring method (detection limit) or empirically.

In the context of the present invention, the threshold value is considered to be exceeded preferably if the measured value of the sample for a certain molecular mass is at least twice as high as that of a blank sample (for example, only buffer or solvent), more preferably if the measured value is at least three times as high, even more preferably at least four times as high, and most preferably at least five times as high as that of the blank sample.

The polypeptide marker or markers is/are used in such a way that its/their presence or absence is measured, wherein the presence or absence is indicative of arteriosclerosis. Thus, there are polypeptide markers which are typically present in patients with arteriosclerosis (ill), such as polypeptide markers No. 1, No. 7, No. 8 and No. 9, but absent in subjects with no arteriosclerosis (control). In addition, there are polypeptide markers which are present in subjects with no arteriosclerosis (control), but are less frequently or not at all present in subjects with arteriosclerosis. These are, for example, the polypeptide markers No. 2, No. 3, No. 4, No. 5 and No. 6.

TABLE 3
Polypeptide markers for the diagnosis of arteriosclerosis, their
molecular masses and migration times, and their presence and absence
in patients suffering from arteriosclerosis and controls (sample
processing and measurement as described in the Example):

| Polypeptide | Molecular | Migration time | | | |
|---|---|---|---|---|---|
| marker No. | mass [Da] | [min] | ill | control | Δ |
| 1 | 2511.8 | 26.4 | 0.60 | 0.00 | 0.60 |
| 2 | 1864.7 | 49.2 | 0.20 | 0.78 | 0.58 |
| 3 | 2799.8 | 46.0 | 0.20 | 0.78 | 0.58 |
| 4 | 1340.6 | 66.7 | 0.10 | 0.67 | 0.57 |
| 5 | 1422.8 | 61.2 | 0.00 | 0.56 | 0.56 |
| 6 | 5882.0 | 33.3 | 0.00 | 0.56 | 0.56 |
| 7 | 1397.4 | 24.9 | 0.50 | 0.00 | 0.50 |
| 8 | 1886.6 | 44.7 | 0.50 | 0.00 | 0.50 |
| 9 | 4642.6 | 37.5 | 0.50 | 0.00 | 0.50 |

ill proportion of subjects with arteriosclerosis in which the polypeptide marker was present in the sample
control proportion of subjects not suffering from arteriosclerosis in which the polypeptide marker was present in the sample
Δ absolute value of (ill - control)

The subject from which the sample in which the presence or absence of one or more polypeptide markers is determined is derived may be any subject which is capable of suffering from arteriosclerosis, for example, an animal or human. Preferably, the subject is a mammal, such as a dog, a horse, a cat, and most preferably, it is a human.

In a preferred embodiment of the invention, not just one polypeptide marker, but a combination of polypeptide markers are used to diagnose arteriosclerosis, wherein the existence of arteriosclerosis can be concluded from their presence or absence. By comparing a plurality of polypeptide markers, a bias in the overall result from a few individual deviations from the typical presence probability in the sick or control individual can be reduced or avoided.

Therefore, in a preferred embodiment of the invention, two polypeptide markers of Table 1 or 2 are used for the diagnosis of arteriosclerosis. In particular, they are the combinations of the following polypeptide markers:
No. 1 and No. 2, No. 1 and No. 3, No. 1 and No. 4, No. 1 and No. 5, No. 1 and No. 6, No. 1 and No. 7, No. 1 and No. 8, No. 1 and No. 9,
No. 2 and No. 3, No. 2 and No. 4, No. 2 and No. 5, No. 2 and No. 6, No. 2 and No. 7, No. 2 and No. 8, No. 2 and No. 9,
No. 3 and No. 4, No. 3 and No. 5, No. 3 and No. 6, No. 3 and No. 7, No. 3 and No. 8, No. 3 and No. 9,
No. 4 and No. 5, No. 4 and No. 6, No. 4 and No. 7, No. 4 and No. 8, No. 4 and No. 9,
No. 5 and No. 6, No. 5 and No. 7, No. 5 and No. 8, No. 5 and No. 9,
No. 6 and No. 7, No. 6 and No. 8, No. 6 and No. 9,
No. 7 and No. 8, No. 7 and No. 9 or
No. 8 and No. 9.

In another, even more preferred embodiment of the invention, three polypeptide markers of Table 1 or 2 are used for the diagnosis of arteriosclerosis. In particular, they are the combinations of the following polypeptide markers:
No. 1 and No. 2 in combination with one of peptide markers No. 3, No. 4, No. 5, No. 6, No. 7, No. 8 or No. 9,
No. 1 and No. 3 in combination with one of peptide markers No. 4, No. 5, No. 6, No. 7, No. 8 or No. 9,
No. 1 and No. 4 in combination with one of peptide markers No. 5, No. 6, No. 7, No. 8 or No. 9,
No. 1 and No. 5 in combination with one of peptide markers No. 6, No. 7, No. 8 or No. 9,
No. 1 and No. 6 in combination with one of peptide markers No. 7, No. 8 or No. 9,
No. 1 and No. 7 in combination with one of peptide markers No. 8 or No. 9,
No. 1 and No. 8 in combination with peptide marker No. 9,
No. 2 and No. 3 in combination with one of peptide markers No. 4, No. 5, No. 6, No. 7, No. 8 or No. 9,
No. 2 and No. 4 in combination with one of peptide markers No. 5, No. 6, No. 7, No. 8 or No. 9,
No. 2 and No. 5 in combination with one of peptide markers No. 6, No. 7, No. 8 or No. 9,
No. 2 and No. 6 in combination with one of peptide markers No. 7, No. 8 or No. 9,
No. 2 and No. 7 in combination with one of peptide markers No. 8 or No. 9,
No. 2 and No. 8 in combination with No. 9,
No. 3 and No. 4 in combination with one of peptide markers No. 5, No. 6, No. 7, No. 8 or No. 9,
No. 3 and No. 5 in combination with one of peptide markers No. 6, No. 7, No. 8 or No. 9,
No. 3 and No. 6 in combination with one of peptide markers No. 7, No. 8 or No. 9,
No. 3 and No. 7 in combination with one of peptide markers No. 8 or No. 9,
No. 3 and No. 8 in combination with No. 9,
No. 4 and No. 5 in combination with one of peptide markers No. 6, No. 7, No. 8 or No. 9,
No. 4 and No. 6 in combination with one of peptide markers No. 7, No. 8 or No. 9,
No. 4 and No. 7 in combination with one of peptide markers No. 8 or No. 9,
No. 4 and No. 8 in combination with No. 9,
No. 5 and No. 6 in combination with one of peptide markers No. 7, No. 8 or No. 9,
No. 5 and No. 7 in combination with one of peptide markers No. 8 or No. 9,
No. 5 and No. 8 in combination with No. 9,
No. 6 and No. 7 in combination with No. 8 or No. 9,
No. 6 and No. 8 in combination with No. 9 or
No. 7 and No. 8 in combination with No. 9.

In another, even more preferred embodiment of the invention, four polypeptide markers of Table 1 or 2 are used for the diagnosis of arteriosclerosis. In particular, they are the combinations of the following polypeptide markers:
No. 1, No. 2 and No. 3 in combination with one of peptide markers No. 4, No. 5, No. 6, No. 7, No. 8 or No. 9,
No. 1, No. 2 and No. 4 in combination with one of peptide markers No. 5, No. 6, No. 7, No. 8 or No. 9,
No. 1, No. 2 and No. 5 in combination with one of peptide markers No. 6, No. 7, No. 8 or No. 9,
No. 1, No. 2 and No. 6 in combination with one of peptide markers No. 7, No. 8 or No. 9,
No. 1, No. 2 and No. 7 in combination with one of peptide markers No. 8 or No. 9,
No. 1, No. 2 and No. 8 in combination with No. 9,
No. 1, No. 3 and No. 4 in combination with one of peptide markers No. 5, No. 6, No. 7, No. 8 or No. 9,
No. 1, No. 3 and No. 5 in combination with one of peptide markers No. 6, No. 7, No. 8 or No. 9,
No. 1, No. 3 and No. 6 in combination with one of peptide markers No. 7, No. 8 or No. 9,
No. 1, No. 3 and No. 7 in combination with one of peptide markers No. 8 or No. 9,
No. 1, No. 3 and No. 8 in combination with No. 9,
No. 1, No. 4 and No. 5 in combination with one of peptide markers No. 6, No. 7, No. 8 or No. 9,
No. 1, No. 4 and No. 6 in combination with one of peptide markers No. 7, No. 8 or No. 9,
No. 1, No. 4 and No. 7 in combination with one of peptide markers No. 8 or No. 9,
No. 1, No. 4 and No. 8 in combination with No. 9,
No. 1, No. 5 and No. 6 in combination with one of peptide markers No. 7, No. 8 or No. 9,
No. 1, No. 5 and No. 7 in combination with one of peptide markers No. 8 or No. 9,
No. 1, No. 5 and No. 8 in combination with No. 9,
No. 1, No. 6 and No. 7 in combination with one of peptide markers No. 8 or No. 9,
No. 1, No. 6 and No. 8 in combination with No. 9,
No. 1, No. 7 and No. 8 in combination with No. 9,
No. 2, No. 3 and No. 4 in combination with one of peptide markers No. 5, No. 6, No. 7, No. 8 or No. 9,
No. 2, No. 3 and No. 5 in combination with one of peptide markers No. 6, No. 7, No. 8 or No. 9,
No. 2, No. 3 and No. 6 in combination with one of peptide markers No. 7, No. 8 or No. 9,
No. 2, No. 3 and No. 7 in combination with one of peptide markers No. 8 or No. 9,
No. 2, No. 3 and No. 8 in combination with No. 9,
No. 2, No. 4 and No. 5 in combination with one of peptide markers No. 6, No. 7, No. 8 or No. 9,
No. 2, No. 4 and No. 6 in combination with one of peptide markers No. 7, No. 8 or No. 9,
No. 2, No. 4 and No. 7 in combination with one of peptide markers No. 8 or No. 9,
No. 2, No. 4 and No. 8 in combination with No. 9,
No. 2, No. 5 and No. 6 in combination with one of peptide markers No. 7, No. 8 or No. 9,
No. 2, No. 5 and No. 7 in combination with one of peptide markers No. 8 or No. 9,
No. 2, No. 5 and No. 8 in combination with No. 9,
No. 2, No. 6 and No. 7 in combination with one of peptide markers No. 8 or No. 9,
No. 2, No. 6 and No. 8 in combination with No. 9,
No. 2, No. 7 and No. 8 in combination with No. 9,
No. 3, No. 4 and No. 5 in combination with one of peptide markers No. 6, No. 7, No. 8 or No. 9,
No. 3, No. 4 and No. 6 in combination with one of peptide markers No. 7, No. 8 or No. 9,
No. 3, No. 4 and No. 7 in combination with one of peptide markers No. 8 or No. 9,
No. 3, No. 4 and No. 8 in combination with No. 9,
No. 3, No. 5 and No. 6 in combination with one of peptide markers No. 7, No. 8 or No. 9,
No. 3, No. 5 and No. 7 in combination with one of peptide markers No. 8 or No. 9,
No. 3, No. 5 and No. 8 in combination with No. 9,
No. 3, No. 6 and No. 7 in combination with one of peptide markers No. 8 or No. 9,
No. 3, No. 6 and No. 8 in combination with No. 9,
No. 3, No. 7 and No. 8 in combination with No. 9,
No. 4, No. 5 and No. 6 in combination with one of peptide markers No. 7, No. 8 or No. 9,
No. 4, No. 5 and No. 7 in combination with one of peptide markers No. 8 or No. 9,
No. 4, No. 5 and No. 8 in combination with No. 9,
No. 4, No. 6 and No. 7 in combination with one of peptide markers No. 8 or No. 9,
No. 4, No. 6 and No. 8 in combination with No. 9,
No. 4, No. 7 and No. 8 in combination with No. 9,
No. 5, No. 6 and No. 7 in combination with one of peptide markers No. 8 or No. 9,
No. 5, No. 6 and No. 8 in combination with No. 9,
No. 5, No. 7 and No. 8 in combination with No. 9 or
No. 6, No. 7 and No. 8 in combination with No. 9.

In another, even more preferred embodiment of the invention, five polypeptide markers of Table 1 or 2 are used for the diagnosis of arteriosclerosis. In particular, they are the combinations of the following polypeptide markers:
No. 1, No. 2, No. 3 and No. 4 in combination with one of peptide markers No. 5, No. 6, No. 7, No. 8 or No. 9,
No. 1, No. 2, No. 3 and No. 5 in combination with one of peptide markers No. 6, No. 7, No. 8 or No. 9,
No. 1, No. 2, No. 3 and No. 6 in combination with one of peptide markers No. 7, No. 8 or No. 9,
No. 1, No. 2, No. 3 and No. 7 in combination with one of peptide markers No. 8 or No. 9,
No. 1, No. 2, No. 3 and No. 8 in combination with polypeptide marker No. 9,
No. 1, No. 2, No. 4 and No. 5 in combination with one of peptide markers No. 6, No. 7, No. 8 or No. 9,
No. 1, No. 2, No. 4 and No. 6 in combination with one of peptide markers No. 7, No. 8 or No. 9,
No. 1, No. 2, No. 4 and No. 7 in combination with one of peptide markers No. 8 or No. 9,
No. 1, No. 2, No. 4 and No. 8 in combination with polypeptide marker No. 9,
No. 1, No. 2, No. 5 and No. 6 in combination with one of peptide markers No. 7, No. 8 or No. 9,
No. 1, No. 2, No. 5 and No. 7 in combination with one of peptide markers No. 8 or No. 9,
No. 1, No. 2 and No. 5, No. 8 in combination with polypeptide marker No. 9,
No. 1, No. 2 and No. 6, No. 7 in combination with one of peptide markers No. 8 or No. 9,
No. 1, No. 2, No. 6 and No. 8 in combination with polypeptide marker No. 9,
No. 1, No. 2, No. 7 and No. 8 in combination with polypeptide marker No. 9,
No. 1, No. 3, No. 4 and No. 5 in combination with one of peptide markers No. 6, No. 7, No. 8 or No. 9,
No. 1, No. 3, No. 4 and No. 6 in combination with one of peptide markers No. 7, No. 8 or No. 9,
No. 1, No. 3, No. 4 and No. 7 in combination with one of peptide markers No. 8 or No. 9,
No. 1, No. 3, No. 4 and No. 8 in combination with polypeptide marker No. 9,
No. 1, No. 3, No. 5 and No. 6 in combination with one of peptide markers No. 7, No. 8 or No. 9,
No. 1, No. 3, No. 5 and No. 7 in combination with one of peptide markers No. 8 or No. 9,
No. 1, No. 3, No. 5 and No. 8 in combination with polypeptide marker No. 9,
No. 1, No. 3, No. 6 and No. 7 in combination with one of peptide markers No. 8 or No. 9,
No. 1, No. 3, No. 6 and No. 8 in combination with polypeptide marker No. 9,
No. 1, No. 3, No. 7 and No. 8 in combination with polypeptide marker No. 9,
No. 1, No. 4, No. 5 and No. 6 in combination with one of peptide markers No. 7, No. 8 or No. 9,
No. 1, No. 4, No. 5 and No. 7 in combination with one of peptide markers No. 8 or No. 9,
No. 1, No. 4, No. 5 and No. 8 in combination with polypeptide marker No. 9,
No. 1, No. 4, No. 6 and No. 7 in combination with one of peptide markers No. 8 or No. 9,
No. 1, No. 4, No. 6 and No. 8 in combination with polypeptide marker No. 9,
No. 1, No. 4, No. 7 and No. 8 in combination with polypeptide marker No. 9,
No. 1, No. 5, No. 6 and No. 7 in combination with one of peptide markers No. 8 or No. 9,
No. 1, No. 5, No. 6 and No. 8 in combination with polypeptide marker No. 9,
No. 1, No. 5, No. 7 and No. 8 in combination with polypeptide marker No. 9,
No. 1, No. 6, No. 7 and No. 8 in combination with polypeptide marker No. 9,
No. 2, No. 3, No. 4 and No. 5 in combination with one of peptide markers No. 6, No. 7, No. 8 or No. 9,
No. 2, No. 3, No. 4 and No. 6 in combination with one of peptide markers No. 7, No. 8 or No. 9,
No. 2, No. 3, No. 4 and No. 7 in combination with one of peptide markers No. 8 or No. 9,
No. 2, No. 3, No. 4 and No. 8 in combination with polypeptide marker No. 9,
No. 2, No. 3, No. 5 and No. 6 in combination with one of peptide markers No. 7, No. 8 or No. 9,
No. 2, No. 3, No. 5 and No. 7 in combination with one of peptide markers No. 8 or No. 9,
No. 2, No. 3, No. 5 and No. 8 in combination with polypeptide marker No. 9,
No. 2, No. 3, No. 6 and No. 7 in combination with one of peptide markers No. 8 or No. 9,
No. 2, No. 3, No. 6 and No. 8 in combination with polypeptide marker No. 9,
No. 2, No. 3, No. 7 and No. 8 in combination with polypeptide marker No. 9,
No. 2, No. 4, No. 5 and No. 6 in combination with one of peptide markers No. 7, No. 8 or No. 9,
No. 2, No. 4, No. 5 and No. 7 in combination with one of peptide markers No. 8 or No. 9,
No. 2, No. 4, No. 5 and No. 8 in combination with polypeptide marker No. 9,
No. 2, No. 4, No. 6 and No. 7 in combination with one of peptide markers No. 8 or No. 9,
No. 2, No. 4, No. 6 and No. 8 in combination with polypeptide marker No. 9,
No. 2, No. 4, No. 7 and No. 8 in combination with polypeptide marker No. 9,
No. 2, No. 5, No. 6 and No. 7 in combination with one of peptide markers No. 8 or No. 9,
No. 2, No. 5, No. 6 and No. 8 in combination with polypeptide marker No. 9,
No. 2, No. 5, No. 7 and No. 8 in combination with polypeptide marker No. 9,
No. 2, No. 6, No. 7 and No. 8 in combination with polypeptide marker No. 9,
No. 3, No. 4, No. 5 and No. 6 in combination with one of peptide markers No. 7, No. 8 or No. 9,
No. 3, No. 4, No. 5 and No. 7 in combination with one of peptide markers No. 8 or No. 9,
No. 3, No. 4, No. 5 and No. 8 in combination with polypeptide marker No. 9,
No. 3, No. 4, No. 6 and No. 7 in combination with one of peptide markers No. 8 or No. 9,
No. 3, No. 4, No. 6 and No. 8 in combination with polypeptide marker No. 9,
No. 3, No. 4, No. 7 and No. 8 in combination with polypeptide marker No. 9,
No. 3, No. 5, No. 6 and No. 7 in combination with one of peptide markers No. 8 or No. 9,
No. 3, No. 5, No. 6 and No. 8 in combination with polypeptide marker No. 9,
No. 3, No. 5, No. 7 and No. 8 in combination with polypeptide marker No. 9,
No. 3, No. 6, No. 7 and No. 8 in combination with polypeptide marker No. 9,
No. 4, No. 5, No. 6 and No. 7 in combination with one of peptide markers No. 8 or No. 9,
No. 4, No. 5, No. 6 and No. 8 in combination with polypeptide marker No. 9,
No. 4, No. 5, No. 7 and No. 8 in combination with polypeptide marker No. 9,
No. 4, No. 6, No. 7 and No. 8 in combination with polypeptide marker No. 9 or
No. 5, No. 6, No. 7 and No. 8 in combination with polypeptide marker No. 9.

In another, even more preferred embodiment of the invention, six polypeptide markers of Table 1 or 2 are used for the diagnosis of arteriosclerosis. In particular, they are the combinations of the following polypeptide markers:
No. 1, No. 2, No. 3, No. 4 and No. 5 in combination with one of peptide markers No. 6, No. 7, No. 8 or No. 9,
No. 1, No. 2, No. 3, No. 4 and No. 6 in combination with one of peptide markers No. 7, No. 8 or No. 9,
No. 1, No. 2, No. 3, No. 4 and No. 7 in combination with one of peptide markers No. 8 or No. 9,
No. 1, No. 2, No. 3, No. 4 and No. 8 in combination with polypeptide marker No. 9,
No. 1, No. 2, No. 3, No. 5 and No. 6 in combination with one of peptide markers No. 7, No. 8 or No. 9,
No. 1, No. 2, No. 3, No. 5 and No. 7 in combination with one of peptide markers No. 8 or No. 9,
No. 1, No. 2, No. 3, No. 5 and No. 8 in combination with polypeptide marker No. 9,
No. 1, No. 2, No. 3, No. 6 and No. 7 in combination with one of peptide markers No. 8 or No. 9,
No. 1, No. 2, No. 3, No. 6 and No. 8 in combination with polypeptide marker No. 9,
No. 1, No. 2, No. 3, No. 7 and No. 8 in combination with polypeptide marker No. 9,
No. 1, No. 2, No. 4, No. 5 and No. 6 in combination with one of peptide markers No. 7, No. 8 or No. 9,
No. 1, No. 2, No. 4, No. 5 and No. 7 in combination with one of peptide markers No. 8 or No. 9,
No. 1, No. 2, No. 4, No. 5 and No. 8 in combination with polypeptide marker No. 9,
No. 1, No. 2, No. 4, No. 6 and No. 7 in combination with one of peptide markers No. 8 or No. 9,
No. 1, No. 2, No. 4, No. 6 and No. 8 in combination with polypeptide marker No. 9,
No. 1, No. 2, No. 4, No. 7 and No. 8 in combination with polypeptide marker No. 9,
No. 1, No. 2, No. 5, No. 6 and No. 7 in combination with one of peptide markers No. 8 or No. 9,
No. 1, No. 2, No. 5, No. 6 and No. 8 in combination with polypeptide marker No. 9,
No. 1, No. 2, No. 5, No. 7 and No. 8 in combination with polypeptide marker No. 9,
No. 1, No. 2, No. 6, No. 7 and No. 8 in combination with polypeptide marker No. 9,
No. 1, No. 3, No. 4, No. 5 and No. 6 in combination with one of peptide markers No. 7, No. 8 or No. 9,
No. 1, No. 3, No. 4, No. 5 and No. 7 in combination with one of peptide markers No. 8 or No. 9,
No. 1, No. 3, No. 4, No. 5 and No. 8 in combination with polypeptide marker No. 9,
No. 1, No. 3, No. 4, No. 6 and No. 7 in combination with one of peptide markers No. 8 or No. 9,
No. 1, No. 3, No. 4, No. 6 and No. 8 in combination with polypeptide marker No. 9,
No. 1, No. 3, No. 4, No. 7 and No. 8 in combination with polypeptide marker No. 9,
No. 1, No. 3, No. 5, No. 6 and No. 7 in combination with one of peptide markers No. 8 or No. 9,
No. 1, No. 3, No. 5, No. 6 and No. 8 in combination with polypeptide marker No. 9,
No. 1, No. 3, No. 5, No. 7 and No. 8 in combination with polypeptide marker No. 9,
No. 1, No. 3, No. 6, No. 7 and No. 8 in combination with polypeptide marker No. 9,
No. 1, No. 4, No. 5, No. 6 and No. 7 in combination with one of peptide markers No. 8 or No. 9,
No. 1, No. 4, No. 5, No. 6 and No. 8 in combination with polypeptide marker No. 9,
No. 1, No. 4, No. 5, No. 7 and No. 8 in combination with polypeptide marker No. 9,
No. 1, No. 4, No. 6, No. 7 and No. 8 in combination with polypeptide marker No. 9,
No. 1, No. 5, No. 6, No. 7 and No. 8 in combination with polypeptide marker No. 9,
No. 2, No. 3, No. 4, No. 5 and No. 6 in combination with one of peptide markers No. 7, No. 8 or No. 9,
No. 2, No. 3, No. 4, No. 5 and No. 7 in combination with one of peptide markers No. 8 or No. 9,
No. 2, No. 3, No. 4, No. 5 and No. 8 in combination with polypeptide marker No. 9,
No. 2, No. 3, No. 4, No. 6 and No. 7 in combination with one of peptide markers No. 8 or No. 9,
No. 2, No. 3, No. 4, No. 6 and No. 8 in combination with polypeptide marker No. 9,
No. 2, No. 3, No. 4, No. 7 and No. 8 in combination with polypeptide marker No. 9,
No. 2, No. 3, No. 5, No. 6 and No. 7 in combination with one of peptide markers No. 8 or No. 9,
No. 2, No. 3, No. 5, No. 6 and No. 8 in combination with polypeptide marker No. 9,
No. 2, No. 3, No. 5, No. 7 and No. 8 in combination with polypeptide marker No. 9,
No. 2, No. 3, No. 6, No. 7 and No. 8 in combination with polypeptide marker No. 9,
No. 2, No. 4, No. 5, No. 6 and No. 7 in combination with one of peptide markers No. 8 or No. 9,
No. 2, No. 4, No. 5, No. 6 and No. 8 in combination with polypeptide marker No. 9,
No. 2, No. 4, No. 5, No. 7 and No. 8 in combination with polypeptide marker No. 9,
No. 2, No. 4, No. 6, No. 7 and No. 8 in combination with polypeptide marker No. 9,
No. 2, No. 5, No. 6, No. 7 and No. 8 in combination with polypeptide marker No. 9,
No. 3, No. 4, No. 5, No. 6 and No. 7 in combination with one of peptide markers No. 8 or No. 9,
No. 3, No. 4, No. 5, No. 6 and No. 8 in combination with polypeptide marker No. 9,
No. 3, No. 4, No. 5, No. 7 and No. 8 in combination with polypeptide marker No. 9,
No. 3, No. 4, No. 6, No. 7 and No. 8 in combination with polypeptide marker No. 9,
No. 3, No. 5, No. 6, No. 7 and No. 8 in combination with polypeptide marker No. 9 or
No. 4, No. 5, No. 6, No. 7 and No. 8 in combination with polypeptide marker No. 9.

In another, even more preferred embodiment of the invention, seven polypeptide markers of Table 1 or 2 are used for the diagnosis of arteriosclerosis. In particular, they are the combinations of the following polypeptide markers:
No. 1, No. 2, No. 3, No. 4, No. 5 and No. 6 in combination with one of peptide markers No. 7, No. 8 or No. 9,
No. 1, No. 2, No. 3, No. 4, No. 5 and No. 7 in combination with one of peptide markers No. 8 or No. 9,
No. 1, No. 2, No. 3, No. 4, No. 5 and No. 8 in combination with polypeptide marker No. 9,
No. 1, No. 2, No. 3, No. 4, No. 6 and No. 7 in combination with one of peptide markers No. 8 or No. 9,
No. 1, No. 2, No. 3, No. 4, No. 6 and No. 8 in combination with polypeptide marker No. 9,
No. 1, No. 2, No. 3, No. 4, No. 7 and No. 8 in combination with polypeptide marker No. 9,
No. 1, No. 2, No. 3, No. 5, No. 6 and No. 7 in combination with one of peptide markers No. 8 or No. 9,
No. 1, No. 2, No. 3, No. 5, No. 6 and No. 8 in combination with polypeptide marker No. 9,
No. 1, No. 2, No. 3, No. 5, No. 7 and No. 8 in combination with polypeptide marker No. 9,
No. 1, No. 2, No. 3, No. 6, No. 7 and No. 8 in combination with polypeptide marker No. 9,
No. 1, No. 2, No. 4, No. 5, No. 6 and No. 7 in combination with one of peptide markers No. 8 or No. 9,
No. 1, No. 2, No. 4, No. 5, No. 6 and No. 8 in combination with polypeptide marker No. 9,
No. 1, No. 2, No. 4, No. 5, No. 7 and No. 8 in combination with polypeptide marker No. 9,
No. 1, No. 2, No. 4, No. 6, No. 7 and No. 8 in combination with polypeptide marker No. 9,
No. 1, No. 2, No. 5, No. 6, No. 7 and No. 8 in combination with polypeptide marker No. 9,
No. 1, No. 3, No. 4, No. 5, No. 6 and No. 7 in combination with one of peptide markers No. 8 or No. 9,
No. 1, No. 3, No. 4, No. 5, No. 6 and No. 8 in combination with polypeptide marker No. 9,
No. 1, No. 3, No. 4, No. 5, No. 7 and No. 8 in combination with polypeptide marker No. 9,
No. 1, No. 3, No. 4, No. 6, No. 7 and No. 8 in combination with polypeptide marker No. 9,
No. 1, No. 3, No. 5, No. 6, No. 7 and No. 8 in combination with polypeptide marker No. 9,
No. 1, No. 4, No. 5, No. 6, No. 7 and No. 8 in combination with polypeptide marker No. 9,
No. 2, No. 3, No. 4, No. 5, No. 6 and No. 7 in combination with one of peptide markers No. 8 or No. 9,
No. 2, No. 3, No. 4, No. 5, No. 6 and No. 8 in combination with polypeptide marker No. 9,
No. 2, No. 3, No. 4, No. 5, No. 7 and No. 8 in combination with polypeptide marker No. 9,
No. 2, No. 3, No. 4, No. 6, No. 7 and No. 8 in combination with polypeptide marker No. 9,
No. 2, No. 3, No. 5, No. 6, No. 7 and No. 8 in combination with polypeptide marker No. 9,
No. 2, No. 4, No. 5, No. 6, No. 7 and No. 8 in combination with polypeptide marker No. 9 or
No. 3, No. 4, No. 5, No. 6, No. 7 and No. 8 in combination with polypeptide marker No. 9.

In another, even more preferred embodiment of the invention, eight polypeptide markers of Table 1 or 2 are used for the diagnosis of arteriosclerosis. In particular, they are the combinations of the following polypeptide markers:
No. 1, No. 2, No. 3, No. 4, No. 5, No. 6, No. 7 and No. 8,
No. 1, No. 2, No. 3, No. 4, No. 5, No. 6, No. 7 and No. 9,
No. 1, No. 2, No. 3, No. 4, No. 5, No. 6, No. 8 and No. 9,
No. 1, No. 2, No. 3, No. 4, No. 5, No. 7, No. 8 and No. 9,
No. 1, No. 2, No. 3, No. 4, No. 6, No. 7, No. 8 and No. 9,
No. 1, No. 2, No. 3, No. 5, No. 6, No. 7, No. 8 and No. 9,
No. 1, No. 2, No. 4, No. 5, No. 6, No. 7, No. 8 and No. 9,
No. 1, No. 3, No. 4, No. 5, No. 6, No. 7, No. 8 and No. 9 or
No. 2, No. 3, No. 4, No. 5, No. 6, No. 7, No. 8 and No. 9.

In another, even more preferred embodiment of the invention, nine polypeptide markers of Table 1 or 2 are used for the diagnosis of arteriosclerosis. In particular, they are the combinations of the following polypeptide markers:
No. 1, No. 2, No. 3, No. 4, No. 5, No. 6, No. 7, No. 8 and No. 9.

In addition to the above mentioned polypeptide markers, the presence or absence of at least one further polypeptide can be used as a marker for the diagnosis of arteriosclerosis if such polypeptide is indicative of arteriosclerosis or the absence of arteriosclerosis (control, for example, healthy state). For example, the mentioned polypeptide consists of at least ten amino acids connected through peptide links. Preferably, the polypeptide consists of a maximum of 100 amino acids. More preferably, the polypeptide has a molecular weight of about 500 to 15,000 Da, even more preferably about 750 to about 10,000 Da, especially about 1000 to about 7,500 Da. Said markers may be chemically modified, for example, by posttranslational modifications, such as glycosylation, phosphorylation, alkylation or disulfide bridges, or by other reactions, for example, within the scope of the degradation. In addition, the polypeptide markers may also be chemically altered, for example, oxidized, within the scope of the purification of the samples.

The sample in which the presence or absence of the peptide marker or markers according to the invention is measured may be any sample which is obtained from the body of the subject. The sample is a sample which has a polypeptide composition suitable for providing information about the state of the subject (arteriosclerosis or healthy, i.e., subject with no arteriosclerosis). For example, it may be blood, urine, synovial fluid, a tissue fluid, a body secretion, sweat, cerebrospinal fluid, lymph, intestinal, gastric or pancreatic juice, bile, lacrimal fluid, a tissue sample, sperm, vaginal fluid or a feces sample. Preferably, it is a liquid sample.

In a preferred embodiment, the sample is a urine sample or blood sample, most preferably a (blood) serum or (blood) plasma sample.

Urine samples can be taken as preferred in the prior art. Preferably, a midstream urine sample is used as said urine sample in the context of the present invention. For example, the urine sample may also be taken by means of a urination apparatus as described in WO 01/74275.

Blood samples can be taken by methods known in the prior art, for example, from a vein, artery or capillary. Usually, a blood sample is obtained by withdrawing venous blood by means of a syringe, for example, from an arm of the subject. The term “blood sample” includes samples obtained from blood by further purification and separation methods, such as (blood) plasma or (blood) serum.

Blood plasma is obtained from blood by removing all cellular components, for example, by centrifugation. The centrifugation may be effected, for example, in the presence of coagulation inhibitors, such as sodium citrate, since the coagulation factors are still present in the plasma. Blood serum essentially corresponds to blood plasma from which the coagulation-active proteins, mainly fibrinogen, have been removed, for example, by blood clotting.

Methods for the preparation of blood plasma and blood serum are generally known in the prior art. In addition, WO 04/65958 discloses a process for removing fibrinogen from plasma. Compositions for the separation of serum or plasma are disclosed, for example, in WO 03/48764 (see also US 2004/129631). Devices and processes for collecting plasma or serum samples from blood are described, for example, in US 2004/31746.

The presence or absence of a polypeptide marker in the sample may be determined by any method known in the prior art that is suitable for measuring polypeptide markers. Such methods are known to the skilled person. In principle, the presence or absence of a polypeptide marker can be determined by direct methods, such as mass spectrometry, or indirect methods, for example, by means of ligands.

If required or desirable, the sample from the subject, for example, the urine or blood sample, may be pretreated by any suitable means and, for example, purified or separated before the presence or absence of the polypeptide marker or markers is measured. The treatment may comprise, for example, purification, separation, dilution or concentration. The methods may be, for example, centrifugation, filtration, ultrafiltration, dialysis, precipitation or chromatographic methods, such as affinity separation or separation by means of ion-exchange chromatography, electrophoretic separation, i.e., separation by different migration behaviors of electrically charged particles in solution upon application of an electric field. Particular examples thereof are gel electrophoresis, two-dimensional polyacrylamide gel electrophoresis (2D-PAGE), capillary electrophoresis, metal affinity chromatography, immobilized metal affinity chromatography (IMAC), lectin-based affinity chromatography, liquid chromatography, high-performance liquid chromatography (HPLC), normal and reverse-phase HPLC, cation-exchange chromatography and selective binding to surfaces. All these methods are well known to the skilled person, and the skilled person will be able to select the method as a function of the sample employed and the method for determining the presence or absence of the polypeptide marker or markers.

In one embodiment of the invention, the sample, before being separated by capillary electrophoresis, is separated, purified by ultracentrifugation and/or divided by ultrafiltration into fractions which contain polypeptide markers of a particular molecular size.

Preferably, a mass-spectrometric method is used to determine the presence or absence of a polypeptide marker, wherein a purification or separation of the sample may be performed upstream from such method. As compared to the currently employed methods, mass-spectrometric analysis has the advantage that the concentration of many (>100) polypeptides of a sample can be determined by a single analysis. Any type of mass spectrometer may be employed. By means of mass spectrometry, it is possible to measure 10 fmol of a polypeptide marker, i.e., 0.1 ng of a 10 kD protein, as a matter of routine with a measuring accuracy of about ±0.01% in a complex mixture. In mass spectrometers, an ion-forming unit is coupled with a suitable analytic device. For example, electrospray-ionization (ESI) interfaces are mostly used to measure ions in liquid samples, whereas MALDI is used most frequently for preparing ions from individually prepared samples. Various kinds of analytic devices are available, for example, ion-trap analytic devices or TOF analytic devices. Both ESI and MALDI may be combined with essentially all types of mass spectrometers, although ESI is usually combined with ion traps, and MALDI with TOF.

In electrospray ionization (ESI), the molecules present in solution are atomized, inter alia, under the influence of high voltage (e.g., 1-8 kV), which forms charged droplets at first that become smaller from the evaporation of the solvent. Finally, the formation of free ions in the gas phase occurs.

In mass spectrometry by means of a time-of-flight (TOF) mass spectrometer, a particular acceleration voltage is applied which confers an equal amount of kinetic energy to the ions. Thereafter, the time that the respective ions take to travel a particular drifting distance through the flying tube is measured very accurately, because with equal amounts of kinetic energy, the velocity of the ions depends on their mass. TOF mass spectrometers have a very high scanning speed and therefore reach a good resolution.

Preferred methods for the determination of the presence and absence of polypeptide markers include gas-phase ion spectrometry, such as laser desorption/ionization mass spectrometry, SELDI-TOF MS (surface-enhanced laser desorption/ionization time-of-flight mass spectrometry), MALDI-TOF MS (matrix-assisted laser desorption/ionization time-of-flight mass spectrometry), 2D-PAGE/MS and capillary electrophoresis-mass spectrometry (CE-MS). 2D-PAGE is usually employed for separating polypeptides and can be used together with mass spectrometry for the identification of individual polypeptides (2D-PAGE/MS). More than 1000 protein spots can be distinguished by means of 2D-PAGE. However, every single polypeptide spot must be separately identified by mass-spectrometric methods.

In the SELDI system, the protein chip is the most important component. The samples to be analyzed are directly applied to the spots present on the arrays. There are different arrays, e.g., chromatographic arrays which represent hydrophobic, hydrophilic, cation-exchange, anion-exchange and immobilized metal-ion affinity surfaces, and preactivated arrays with chemical groups which allow for covalent binding. Cation-exchange surfaces are preferred. In the SELDI method, only those polypeptides that actually bind to the surface of the chip are measured. After the binding of the sample polypeptides, an energy-absorbing matrix is applied to each spot. After the matrix has crystallized, the protein chip array is usually evaluated in a protein chip reader for analysis.

The reader is a TOF (time-of-flight) mass spectrometer in which the proteins are desorbed and ionized by means of a laser. Since the crystallized proteins are equally distributed on the spot surface, the ionizing laser beam always hits a representative average of the molecules in the analyte, which allows for a quantitative determination. After the ionization, the polypeptides are accelerated in an electric field before impinging on a detector. The duration of the flight from the laser irradiation of the array surface to the impingement of the molecule on the detector allows an accurate determination of the molecular mass of the polypeptide in the sample (see, e.g., the following survey article: Merchant, M. and Weinberger, S. R., Electrophoresis, Vol. 212: 1164-1177, 2000).

A particularly preferred method is CE-MS, in which capillary electrophoresis is coupled with mass spectrometry. This method has been described in some detail, for example, in the German Patent Application DE 10021737, in Kaiser et al. (J Chromatogr A, Vol. 1013: 157-171, 2003, and Electrophoresis, 25: 2044-2055, 2004) and in Wittke et al. (Journal of Chromatography A, 1013: 173-181, 2003). The CE-MS technology allows to determine the presence of some hundreds of polypeptide markers simultaneously within a short time and in a small volume with high sensitivity. After a sample containing polypeptides has been measured, a pattern of the measured polypeptide markers is prepared, and this pattern can be compared with a pattern of a sick or healthy human. In most cases, it is sufficient to use one or a limited number of polypeptide markers for the diagnosis of arteriosclerosis. In particular, 1, 2, 3, 4, 5, 6, 7, 8 or 9 polypeptide markers from Table 1 or 2 can be measured, preferably in the above stated combinations of polypeptide markers. A CE-MS method which includes capillary electrophoresis coupled, e.g., on-line, to an ESI-TOF analytical device is further preferred. Here, the sample is applied to an electrophoretic capillary, and a voltage, e.g., of up to 50 kV, especially up to 30 kV, is applied.

For CE-MS, the use of volatile solvents is preferred, and it is best to work under essentially salt-free conditions. Examples of such solvents include acetonitrile, Isopropanol, methanol and the like. The solvents can be mixed with water or a weak acid (e.g., 0.1% formic acid) in order to protonate the analyte. The polypeptide markers in the sample are separated by their size and charge, which determine the time of flight in the capillary.

By means of capillary electrophoresis, it is possible to separate molecules by their charge and size. Neutral particles will migrate at the speed of the electroosmotic flow upon application of a current, while cations are accelerated towards the cathode, and anions are delayed. The advantage of the capillaries in electrophoresis resides in the favorable ratio of surface to volume, which enables a good dissipation of the Joule heat generated during the current flow. This in turn allows high voltages (usually up to 30 kV) to be applied and thus a high separating performance and short times of analysis.

In capillary electrophoresis, silica glass capillaries are usually employed. By using capillaries of small inner diameter, both radial diffusion and convection are avoided. In order to be able to sufficiently dissipate to the environment the heat generated by current flow in the capillary at the voltage applied, the inner diameters of the capillaries must be kept small. Capillaries having inner diameters of 50-75 μm are usually employed. The lengths employed are, for example, 30-100 cm. With capillaries of such dimensions, it is usually ensured that the temperature increase in the capillary from released ionic heat will not result in the formation of gas bubbles in the capillary. In addition, the separating capillaries are usually made of plastic-coated silica glass. The capillaries may be both untreated, i.e., expose their hydrophobic groups on the interior surface, or coated on the interior surface. A hydrophobic coating may be used to improve the resolution. In addition to the voltage, a pressure may also be applied, which typically is within a range of from 0 to 1 psi. The pressure may also be applied only during the performance or altered meanwhile.

In order to improve the resolution, a stacking protocol may be used during the loading: Before the sample is loaded, a base is loaded, then the sample is loaded, and then an acid. The ions of the analyte are thereby contained between the acid and the base. When a voltage is applied, positively charged analyte ions are moved towards the base. At the base, they become negatively charged and are moved in the opposite direction, where they become positively charged. This is repeated until the acids and bases are neutralized. Thus, a concentrated sample is obtained. Before being loaded, the sample may be diluted with a suitable buffer.

For the detection of the polypeptide markers separated by means of capillary electrophoresis, the capillary electrophoresis device is preferably coupled to a mass spectrometer. Mass spectrometry allows for the determination of the molecular masses of free ions in a high vacuum. It contains a mass analyzer which separates the ions by their mass-to-charge ratio (m/z), and a detector.

In a still further preferred method for measuring polypeptide markers in a sample, the polypeptide markers of the sample are separated by capillary electrophoresis, then directly ionized and transferred on-line through an interface into a coupled mass spectrometer for detection.

The present invention further relates to a method for the diagnosis of arteriosclerosis by:
a) measuring the presence or absence of at least one polypeptide marker in a sample from a subject, said polypeptide marker being defined as in claim 1 or 2; and
b) establishing the probability of the existence of arteriosclerosis in said subject, wherein:
   i) if the probability of the presence of the polypeptide marker in a sick subject is higher than the probability of the presence of the same polypeptide marker in a control subject, then the presence of the polypeptide marker is indicative of a higher probability of the existence of arteriosclerosis;
   ii) if the probability of the presence of the polypeptide marker in a sick subject is lower than the probability of the presence of the same polypeptide marker in a control subject, then the absence of the polypeptide marker is indicative of a higher probability of the existence of arteriosclerosis;
   iii) if the probability of the presence of the polypeptide marker in a sick subject is higher than the probability of the presence of the same polypeptide marker in a control subject, then the absence of the polypeptide marker is indicative of a higher probability of the non-existence of arteriosclerosis; or
   iv) if the probability of the presence of the polypeptide marker in a sick subject is lower than the probability of the presence of the same polypeptide marker in a control subject, then the presence of the polypeptide marker is indicative of a higher probability of the non-existence of arteriosclerosis.

In one embodiment of the method according to the invention, the probabilities in step b) of the presence of a polypeptide marker in a subject suffering from arteriosclerosis (sick subject) or in a control subject are as follows:

| | | | Probability of the presence of | |
|---|---|---|---|---|
| Polypeptide | Molecular | Migration | the polypeptide marker in a | |
| marker No. | mass [Da] | time [min] | sick subject | control subject |
| 1 | 2511.8 | 26.4 | 0.60 | 0.00 |
| 2 | 1864.7 | 49.2 | 0.20 | 0.78 |
| 3 | 2799.8 | 46.0 | 0.20 | 0.78 |
| 4 | 1340.6 | 66.7 | 0.10 | 0.67 |
| 5 | 1422.8 | 61.2 | 0.00 | 0.56 |
| 6 | 5882.0 | 33.3 | 0.00 | 0.56 |
| 7 | 1397.4 | 24.9 | 0.50 | 0.00 |
| 8 | 1886.6 | 44.7 | 0.50 | 0.00 |
| 9 | 4642.6 | 37.5 | 0.50 | 0.00 |

In a preferred embodiment, the control subject is a subject that does not suffer from arteriosclerosis. In a further preferred embodiment, it is a human who does not suffer from arteriosclerosis.

In the method according to the invention, it is advantageous to use several polypeptide markers for diagnosis. In particular, at least 2, 3, 4, 5, 6, 7, 8 or 9 polypeptide markers of Table 1 or Table 2 may be used. Still more preferably, the combinations of polypeptide markers are the combinations stated above.

In order to determine the probability of the existence of arteriosclerosis when several markers are used, statistic methods known to the skilled person may be used. For example, the method described by Weissinger et al. (Kidney Int. 2004 Jim; 65(6): 2426-24; Random Forests method) may be used by using a computer program such as S-Plus.

In the method according to the invention, the presence of the polypeptide markers No. 1, No. 7, No. 8 and/or No. 9 in the sample and/or the absence of the polypeptide markers No. 2, No. 3, No. 4, No. 5 and/or No. 6 in the sample is indicative of the existence of arteriosclerosis.

For determining the presence or absence, the above mentioned purification, separation and detection methods may be employed in the method according to the invention. Preferably, capillary electrophoresis, gas-phase ion spectrometry and/or mass spectrometry is used for detecting the presence or absence of the polypeptide marker or markers.

In a particularly preferred embodiment, a capillary electrophoresis is performed and/or mass spectrometry is used for detecting the presence or absence of the polypeptide marker or markers, before the molecular mass of the polypeptide markers is measured.

### EXAMPLE

### 1. Sample Preparation

For detecting the polypeptide markers of arteriosclerosis, plasma was employed. Plasma was withdrawn from healthy donors (control) as well as from dialysis-dependent patients suffering from arteriosclerosis. For withdrawing the plasma from healthy donors, S-Monovettes with heparin (Sarstedt, Nümbrecht, Germany) were used, while plasma from dialysis patients was withdrawn directly because these had already been administered heparin. Heparin serves to avoid blood coagulation and proteolytic activity and thus also to protect the proteins and peptides contained in the plasma from degradation by enzymes.

For the subsequent CE-MS measurement, the proteins which are contained in the plasma in a very high concentration, such as albumin and immunoglobulins, had to be separated off by ultrafiltration. Thus, 500 μl of plasma was removed and admixed with 2 ml of filtration buffer (4 mol/l urea, 0.1 mol/l NaCl, 0.01% ammonia). This 2.5 ml of sample volume was ultrafiltrated (Centrisart 20 MWCO, Vivascience, Hannover, Germany). The ultrafiltration was performed at 3400 rpm in a centrifuge until 2 ml of ultrafiltrate was obtained.

The 2 ml of filtrate obtained was then applied to a Pharmacia C-2 column (Pharmacia, Uppsala, Sweden) in order to remove urea, salts and other disturbing components. The bound polypeptides were then eluted from the C-2 column with 50% acetonitrile, 0.5% formic acid in water, and lyophilized. For the CE-MS measurement, the polypeptides were then resuspended with 20 μl of water (HPLC grade, Merck, Darmstadt, Germany).

### 2. CE-MS Measurement

The CE-MS measurements were performed with a capillary electrophoresis system from Beckman Coulter (P/ACE MDQ System; Beckman Coulter Inc., Fullerton, Calif., USA) and an ESI-TOF mass spectrometer from Applied Biosystems (Mariner Biospectrometry Workstation; Applied Biosystems, Foster City, Calif., USA).

The CE capillaries were supplied by Beckman Coulter (supra) and had an ID/OD of 75/360 μm and a length of 90 cm. The mobile phase for the CE separation consisted of 30% methanol and 0.5% formic acid in water, and the same mixture was used for “sheath flow” on the MS at a flow rate of 2 μl/min. The coupling of CE and MS was realized by a CE-ESI-MS Sprayer Kit (Agilent Technologies, Waldbronn, Germany).

For injecting the sample, a pressure of 1 psi was applied, and the duration of the injection was 20 seconds. With these parameters, about 100 nl of the sample was injected into the capillary, which corresponds to about 0.25% of the capillary volume. A stacking technique was used to concentrate the sample in the capillary. Thus, before the sample was injected, a 1 mol/l NH₃ solution was injected for 7 seconds (at 1 psi), and after the sample was injected, a 2 mol/l formic acid solution was injected for 5 seconds. When the separation voltage (30 kV) was applied, the analytes were automatically concentrated between these solutions.

The subsequent CE separation was performed with a pressure method: 40 minutes at 0 psi, then 0.1 psi for 2 min, 0.2 psi for 2 min, 0.3 psi for 2 min, 0.4 psi for 2 min, and finally 0.5 psi for 32 min. The total duration of a separation run was thus 80 minutes.

In order to obtain as good as possible a signal intensity on the side of the MS, the nebulizer gas was turned off. The voltage applied to the spray needle for generating the electrospray was 3200 V, which resulted in an available separation voltage over the whole capillary of about 27 kV. The remaining settings at the Mariner mass spectrometer were optimized for peptide detection according to the manufacturer's protocol. The spectra were recorded over a mass range of m/z 400 to m/z 2500 and accumulated every 3 seconds.

### 3. Standards for the CE Measurement

For checking and standardizing the CE measurement, the following proteins or polypeptides which are characterized by the stated CE migration times were employed:

They may be used for normalizing the CE times of peptide markers 1 to 9 as well as of measured samples.

| Protein/polypeptide | Migration time |
|---|---|
| Aprotinin (SIGMA, Taufkirchen, DE, Cat. # AI 153) | 9.2 min |
| Ribonuclease (SIGMA, Taufkirchen, DE, Cat. # R4875) | 10.9 min |
| Lysozyme (SIGMA, Taufkirchen, DE, Cat. # L7651) | 8.9 min |
| “REV”, Sequence: REVQSKIGYGRQIIS | 15.6 min |
| “ELM”, Sequence: ELMTGELPYSHINNRDQIIFMVGR | 23.4 min |
| “KINCON”, Sequence: TGSLPYSHIGSRDQIIFMVGR | 20.0 min |
| “GIVLY” Sequence: GIVLYELMTGELPYSHIN | 36.8 min |

The proteins/polypeptides were employed at a concentration of 10 μmol/μl each in water.

“REV”, “ELM, “KINCON” and “GIVLY” are synthetic peptides.

The molecular masses of the peptides and the masses of the individual charge states visible in MS are as follows:

| | 1.0079 | 1.0079 | 1.0079 | 1.0079 | 1.0079 | 1.0079 | 1.0079 |
|---|---|---|---|---|---|---|---|
| | Aprotinin | Ribonuclease | Lysozym | REV | KINCON | ELM | GIVLY |
| H Mono | Mono | Mono | Mono | Mono | Mono | Mono | Mono |
| M/z | Mass | Mass | Mass | Mass | Mass | Mass | Mass |
| 0 | 6513.0900 | 13681.3200 | 14303.8800 | 1732.9600 | 2333.1900 | 2832.4100 | 2048.0300 |
| 1 | 6514.0979 | 13682.3279 | 14304.8879 | 1733.9679 | 2334.1979 | 2833.4179 | 2049.0379 |
| 2 | 3257.5529 | 6841.6679 | 7152.9479 | 867.4879 | 1167.6029 | 1417.2129 | 1025.0229 |
| 3 | 2172.0379 | 4561.4479 | 4768.9679 | 578.6612 | 778.7379 | 945.1446 | 683.6846 |
| 4 | 1629.2804 | 3421.3379 | 3576.9779 | 434.2479 | 584.3054 | 709.1104 | 513.0154 |
| 5 | 1303.6259 | 2737.2719 | 2861.7839 | 347.5999 | 467.6459 | 567.4899 | 410.6139 |
| 6 | 1086.5229 | 2281.2279 | 2384.9879 | 289.8346 | 389.8729 | 473.0762 | 342.3462 |
| 7 | 931.4494 | 1955.4822 | 2044.4193 | 248.5736 | 334.3208 | 405.6379 | 293.5836 |
| 8 | 815.1442 | 1711.1729 | 1788.9929 | 217.6279 | 292.6567 | 355.0592 | 257.0117 |
| 9 | 724.6846 | 1521.1546 | 1590.3279 | 193.5590 | 260.2512 | 315.7201 | 228.5668 |
| 10 | 652.3169 | 1369.1399 | 1431.3959 | 174.3039 | 234.3269 | 284.2489 | 205.8109 |
| 11 | 593.1070 | 1244.7643 | 1301.3606 | 158.5497 | 213.1161 | 258.4997 | 187.1924 |
| 12 | 543.7654 | 1141.1179 | 1192.9979 | 145.4212 | 195.4404 | 237.0421 | 171.6771 |
| 13 | 502.0148 | 1053.4171 | 1101.3063 | 134.3125 | 180.4841 | 218.8856 | 158.5486 |

1. Use of the presence or absence of at least one peptide marker in a sample from a subject for the diagnosis of arteriosclerosis, wherein said polypeptide marker is selected from the polypeptide markers No. 1, No. 2, No. 3, No. 4, No. 5, No. 6, No. 7, No. 8 or No. 9, which are characterized by the following values for the molecular mass:

| Polypeptide marker No. | Molecular mass [Da] |
|---|---|
| 1 | 2511.8 |
| 2 | 1864.7 |
| 3 | 2799.8 |
| 4 | 1340.6 |
| 5 | 1422.8 |
| 6 | 5882.0 |
| 7 | 1397.4 |
| 8 | 1886.6 |
| 9 | 4642.6 |

for the diagnosis of arteriosclerosis.

2. The use according to claim 1, wherein said polypeptide marker is selected from the polypeptide markers No. 1, No. 2, No. 3, No. 4, No. 5, No. 6, No. 7, No. 8 or No. 9, which are characterized by the following values for the molecular mass and migration time:

| Polypeptide marker No. | Molecular mass [Da] | Migration time [min] |
|---|---|---|
| 1 | 2511.8 | 26.4 |
| 2 | 1864.7 | 49.2 |
| 3 | 2799.8 | 46.0 |
| 4 | 1340.6 | 66.7 |
| 5 | 1422.8 | 61.2 |
| 6 | 5882.0 | 33.3 |
| 7 | 1397.4 | 24.9 |
| 8 | 1886.6 | 44.7 |
| 9 | 4642.6 | 37.5 |

3. The use according to claim 1, wherein at least two polypeptide markers are used, especially the polypeptide markers:
No. 1 and No. 2, No. 1 and No. 3, No. 1 and No. 4, No. 1 and
No. 5, No. 1 and No. 6, No. 1 and No. 7, No. 1 and No. 8, No. 1 and No. 9,
No. 2 and No. 3, No. 2 and No. 4, No. 2 and No. 5, No. 2 and
No. 6, No. 2 and No. 7, No. 2 and No. 8, No. 2 and No. 9,
No. 3 and No. 4, No. 3 and No. 5, No. 3 and No. 6, No. 3 and
No. 7, No. 3 and No. 8, No. 3 and No. 9,
No. 4 and No. 5, No. 4 and No. 6, No. 4 and No. 7, No. 4 and
No. 8, No. 4 and No. 9,
No. 5 and No. 6, No. 5 and No. 7, No. 5 and No. 8, No. 5 and No. 9,
No. 6 and No. 7, No. 6 and No. 8, No. 6 and No. 9,
No. 7 and No. 8, No. 7 and No. 9 or
No. 8 and No. 9;
said polypeptide markers being as defined in claim 1.

4. The use according to claim 1, wherein at least three polypeptide markers as defined in claim 1 are used.

5. The use according to claim 1, wherein at least four polypeptide markers as defined in claim 1 are used.

6. The use according to claim 1, wherein at least five polypeptide markers as defined in claim 1 are used.

7. The use according to claim 1, wherein at least six polypeptide markers as defined in claim 1 are used.

8. The use according to claim 1, wherein at least seven polypeptide markers as defined in claim 1 are used.

9. The use according to claim 1, wherein at least eight polypeptide markers as defined in claim 1 are used.

10. The use according to claim 1, wherein nine polypeptide markers as defined in claim 1 are used.

11. The use according to claim 1, wherein at least one further polypeptide is used as a marker.

12. The use according to claim 2, wherein said migration time has been determined by capillary electrophoresis at 30 kV in a mobile phase of 30% by volume of methanol, 0.5% by volume of formic acid in water in a capillary having a length of 90 cm.

13. The use according to claim 1, wherein said sample from a subject is a urine sample or blood sample, especially a serum or plasma sample.

14. A method for the diagnosis of arteriosclerosis comprising the steps:
a) measuring the presence or absence of at least one polypeptide marker in a sample from a subject, said polypeptide marker being defined as in claim 1; and
b) establishing the probability of the existence of arteriosclerosis in said subject, wherein:
i) if the probability of the presence of the polypeptide marker in a sick subject is higher than the probability of the presence of the same polypeptide marker in a control subject, then the presence of the polypeptide marker is indicative of a higher probability of the existence of arteriosclerosis;
ii) if the probability of the presence of the polypeptide marker in a sick subject is lower than the probability of the presence of the same polypeptide marker in a control subject, then the absence of the polypeptide marker is indicative of a higher probability of the existence of arteriosclerosis;
iii) if the probability of the presence of the polypeptide marker in a sick subject is higher than the probability of the presence of the same polypeptide marker in a control subject, then the absence of the polypeptide marker is indicative of a higher probability of the non-existence of arteriosclerosis; or
iv) if the probability of the presence of the polypeptide marker in a sick subject is lower than the probability of the presence of the same polypeptide marker in a control subject, then the presence of the polypeptide marker is indicative of a higher probability of the non-existence of arteriosclerosis.

15. The method according to claim 14, wherein the individual probabilities in step b) are as follows:

| | Probability of the presence of the polypeptide | |
|---|---|---|
| | marker in | |
| Polypeptide marker No. | sick subject | control subject |
| 1 | 0.60 | 0.00 |
| 2 | 0.20 | 0.78 |
| 3 | 0.20 | 0.78 |
| 4 | 0.10 | 0.67 |
| 5 | 0.00 | 0.56 |
| 6 | 0.00 | 0.56 |
| 7 | 0.50 | 0.00 |
| 8 | 0.50 | 0.00 |
| 9 | 0.50 | 0.00 |

16. The method according to claim 14, wherein at least 2, 3, 4, 5, 6, 7, 8 or 9 polypeptide markers are used.

17. The method according to claim 14, wherein said polypeptide marker is selected from the polypeptide markers No. 1, No. 2, No. 3, No. 4, No. 5, No. 6, No. 7, No. 8 or No. 9, which are characterized by the following values for the molecular mass:

| Polypeptide marker No. | Molecular mass [Da] |
|---|---|
| 1 | 2511.8 |
| 2 | 1864.7 |
| 3 | 2799.8 |
| 4 | 1340.6 |
| 5 | 1422.8 |
| 6 | 5882.0 |
| 7 | 1397.4 |
| 8 | 1886.6 |
| 9 | 4642.6 |

and wherein at least two polypeptide markers are used, especially the polypeptide markers:
No. 1 and No. 2, No. 1 and No. 3, No. 1 and No. 4, No. 1 and
No. 5, No. 1 and No. 6, No. 1 and No. 7, No. 1 and No. 8, No. 1 and No. 9,
No. 2 and No. 3, No. 2 and No. 4, No. 2 and No. 5, No. 2 and
No. 6, No. 2 and No. 7, No. 2 and No. 8, No. 2 and No. 9,
No. 3 and No. 4, No. 3 and No. 5, No. 3 and No. 6, No. 3 and
No. 7, No. 3 and No. 8, No. 3 and No. 9.

18. The method according to claim 14, wherein the presence of polypeptide markers No. 1, No. 7, No. 8 and/or No. 9 is indicative of the existence of arteriosclerosis.

19. The method according to claim 14, wherein the absence of polypeptide markers No. 2, No. 3, No. 4, No. 5 and/or No. 6 is indicative of the existence of arteriosclerosis.

20. The method according to claim 14, wherein capillary electrophoresis, gasphase ion spectrometry and/or mass spectrometry is used for detecting the presence or absence of said polypeptide marker or markers.

21. The method according to claim 14, wherein a capillary electrophoresis is performed before the molecular mass of said polypeptide markers is measured.

22. The method according to claim 14, wherein mass spectrometry is used for detecting the presence or absence of said polypeptide marker or markers.


SEQUENCE LISTING (4 sequences)

SEQ ID NO: 1 - protein, 15 aa, Artificial sequence
  Description of artificial sequence synthetic peptide
REVQSKIGYGRQIIS

SEQ ID NO: 2 - protein, 24 aa, Artificial sequence
  Description of artificial sequence synthetic peptide
ELMTGELPYSHINNRDQIIFMVGR

SEQ ID NO: 3 - protein, 21 aa, Artificial sequence
  Description of artificial sequence synthetic peptide
TGSLPYSHIGSRDQIIFMVGR

SEQ ID NO: 4 - protein, 18 aa, Artificial sequence
  Description of artificial sequence synthetic peptide
GIVLYELMTGELPYSHIN